(19) United States
(12) Patent Application Publication
(10) Pub. No.: US 2023/0275331 A1
(43) Pub. Date: Aug. 31, 2023

(54) ENERGY STORAGE CELL AND PRODUCTION METHOD

(71) Applicant: VARTA Microbattery GmbH, Ellwangen Jagst (DE)

(72) Inventors: Edward PYTLIK, Ellwangen (DE); David ENSLING, Ellwangen (DE)

(21) Appl. No.: 18/005,619

(22) PCT Filed: Jul. 27, 2021
(86) PCT No.: PCT/EP2021/070968

§ 371 Date: Jan. 16, 2023

(30) Foreign Application Priority Data
Jul. 28, 2020 (EP) 20188237.0

(51) Int. Cl. H01M 50/559; H01M 50/538; H01M 10/0587; H01M 50/107; H01M 50/119; H01M 50/184; H01M 4/75; H01M 50/188; H01M 50/152; H01M 50/169; H01M 10/04; H01M 50/159

(52) U.S. Cl. CPC H01M 50/559; H01M 50/538; H01M 10/0587; H01M 50/107; H01M 50/119; H01M 50/184; H01M 4/75; H01M 50/188; H01M 50/152; H01M 50/169; H01M 10/049; H01M 50/159; H01M 10/0431

(57) ABSTRACT

A an energy storage cell includes an electrode-separator assembly comprising an anode, a cathode, and a separator in a form of a cylindrical winding having two terminal end faces and a winding shell. An anode current collector includes a first longitudinal edge, and a cathode current collector includes a first longitudinal edge. The energy storage cell also includes a tubular housing portion in which the cylindrical winding is aligned axially. An at least partly metallic contact element with a circular edge is in direct contact with and connected the first longitudinal edge of the anode current collector or the first longitudinal edge of the cathode current collector. The energy storage cell further includes an annular seal made of an electrically insulating material that surrounds the circular edge of the contact element. The contact element together with the seal closes a terminal circular opening of the tubular housing portion.

### CROSS REFERENCE TO RELATED APPLICATIONS

This application is a U.S. National Phase application under 35 U.S.C. § 371 of International Application No. PCT/EP2021/070968, filed on Jul. 27, 2021, and claims benefit to European Patent Application No. EP 20188237.0, filed on Jul. 28, 2020. The International Application was published in German on Feb. 3, 2022 as WO 2022/023321 under PCT Article 21(2).

### FIELD

The disclosure relates to an energy storage cell comprising an electrode-separator assembly.

### BACKGROUND

Electrochemical cells are able to convert stored chemical energy to electrical energy through a redox reaction. They generally comprise a positive electrode and a negative electrode that are separated from one another by a separator. During a discharge, electrons are released at the negative electrode as a result of an oxidation process. This results in an electron current that can be drawn off by an external electrical consumer, to which the electrochemical cell acts as energy supplier. At the same time, an ion current corresponding to the electrode reaction occurs within the cell. This ion current passes through the separator and is enabled by an ion-conducting electrolyte.

If the discharge is reversible, i.e. there is the possibility of reversing the conversion of chemical energy to electrical energy that took place during the discharge, and thus of recharging the cell, the cell is called a secondary cell. The designation of the negative electrode as the anode and of the positive electrode as the cathode, which is customary in secondary cells, refers to the discharge function of the electrochemical cell.

Secondary lithium ion cells are used for many applications nowadays, since these are able to provide high currents and are notable for comparatively high energy density. They are based on the use of lithium, which is able to migrate back and forth in the form of ions between the electrodes of the cell. The negative electrode and the positive electrode of a lithium-ion cell are usually formed from what are known as composite electrodes, which, in addition to electrochemically active components, also comprise electrochemically inactive components.

Useful electrochemically active components (active materials) for secondary lithium ion cells are in principle all materials that are able to absorb lithium ions and release them again. Particles based on carbon, for example graphitic carbon, are often used here for the negative electrode. Other non-graphitic carbon materials suitable for lithium intercalation may also be used. In addition, it is also possible to use metallic and semimetallic materials that can be alloyed with lithium. For example, the elements tin, aluminum, antimony, and silicon are able to form intermetallic phases with lithium. Examples of active materials that can be used for the positive electrode include lithium cobalt oxide (LiCoO₂), lithium manganese oxide (LiMn₂O₄), lithium iron phosphate (LiFePO₄) or derivatives thereof. The electrochemically active materials are usually present in the electrodes in particle form.

As electrochemically inactive components, the composite electrodes generally comprise a two-dimensional current collector and/or a band shaped current collector, for example a metallic foil that serves as carrier for the respective active material. The current collector for the negative electrode (anode current collector) can be formed for example from copper or nickel and the current collector for the positive electrode (cathode current collector) can be formed for example from aluminum. In addition, the electrodes may comprise, as electrochemically inactive components, an electrode binder (e.g. polyvinylidene fluoride (PVDF) or another polymer, for example carboxymethylcellulose), conductivity-improving additives and other additions. The electrode binder ensures the mechanical stability of the electrodes and often also the adhesion of the active material to the current collectors.

Lithium ion cells generally comprise, as electrolytes, solutions of lithium salts such as lithium hexafluorophosphate (LiPF₆) in organic solvents (for example ethers and esters of carbonic acid).

In the production of a lithium ion cell, the composite electrodes are combined with one or more separators to give a composite body. In this case, the electrodes and separators are joined to one another, usually under pressure, optionally also by lamination or by adhesive bonding. The fundamental ability of the cell to function can be established by impregnating the assembly with the electrolyte.

In many embodiments, the composite body is formed as a winding or processed to give a winding. In general, it comprises the following sequence: positive electrode/separator/negative electrode. Frequently, composite bodies are produced as what are called bicells having the following possible sequences: negative electrode/separator/positive electrode/separator/negative electrode or positive electrode/separator/negative electrode/separator/positive electrode.

Applications in the automotive sector, E-bikes or else other applications having a high energy demand, for example in vehicles, require lithium ion cells with maximum energy density that are simultaneously capable of being loaded with high currents during charging and discharging.

Frequently, cells for the applications mentioned take the form of round cylindrical cells, for example having the 21×70 shape factor (diameter×height in mm). Cells of this kind always include a composite body in the form of a winding. Modern lithium ion cells of this form factor can already achieve an energy density of up to 270 Wh/kg. However, this energy density is regarded only as an intermediate step. The market is already demanding cells having even higher energy densities.

In the development of improved electrochemical cells, however, energy density is not the only factor to be noted. Exceptionally important parameters are also the internal resistance of the cells, which should be kept at a minimum, in order to reduce power losses during charging and discharging, and the thermal attachment of the electrodes, which can be essential for regulation of the cell temperature. These parameters too are very important for round cylindrical cells containing a composite body in the form of a winding. In the fast charging of cells, power losses can result in occurrence of heat buildup in the cells, which can lead to severe thermomechanical stress and consequently to deformation of and damage to the cell structure. The risk is enhanced when the electrical attachment of the current collectors is via separate electrical output conductor lugs, welded to the current collectors, that emerge axially from wound composite bodies, since heating can occur locally in these output conductor lugs under significant loads in the charging or discharging operation.

WO 2017/215900 A1 describes cells in which the electorate-separator assembly and the electrodes thereof are band shaped and in the form of a winding. The electrodes each have current collectors laden with electrode material. Electrodes of opposite polarity are arranged offset from one another within the electrode-separator assembly, such that longitudinal edges of the current collectors of the positive electrodes protrudes from the winding on one side, and longitudinal edges of the current collectors of negative electrodes on another side. For electrical contact connection of the current collectors, the cell has at least one contact element that lies against one of the longitudinal edges so as to result in a linear contact zone. The contact element is joined to the longitudinal edge along the linear contact zone by welding. This makes it possible to make electrical contact with the current collector and hence also the corresponding electrode over its entire length. This very significantly lowers the internal resistance within the cell described. The occurrence of high currents can be managed very much better as a result.

U.S. Pat. No. 6,432,574 B1 discloses cylindrical round cells in which electrode-separator assemblies likewise in the form of windings are electrically contacted via contact plates that are welded on at the end face. FIG. 2A shows a typical housing for accommodation of such an electrode-separator assembly. It comprises a cup-shaped housing portion in which a wound electrode-separator assembly is aligned axially. The housing is closed by means of a multipart cover, with an annular seal pulled over the edge thereof. To seal the housing, the terminal edge of the cup was bent radially inward over the edge of the cover and the seal that had been pulled over it. To assist this process, the circumferential deep groove immediately beneath the cover is required. In the sealing operation, a tool engages with this, in order that an axial pressure can be exerted from above and below on the edge of the cover and the seal when the terminal edge is being bent over. As a result, the seal is compressed here between the groove and the lower face of the edge of the cover and between the circumferential edge of the cup and the upper face of the edge of the cover, which leads to efficient sealing. However, the groove required is disadvantageous. Firstly, it has to be introduced into the housing in a separate step after the electrode-separator assembly has been inserted. Secondly, the groove requires a dead volume that has to be overcome by means of a conductor in order to establish an electrical contact to the cover. In the case of the cell shown in FIG. 2A, for this purpose, a contact sheet of excess length is welded onto the top end face, bent over and welded onto the inside of the cover.

EP 2924762 A2 discloses cylindrical round cells in which edges of electrodes on a cylindrical electrode-separator assembly in the form of a winding are contacted using contact sheets having an edge region bent over by 90°, in order that the edge thereof can lie flat against the inner wall of a cell housing. Two circumferential beads are introduced into the cell housing. One of the beads serves to press the cell housing directly onto the contact sheet. The other of the beads serves to seal the cell housing; it compresses a sealing ring pulled over the edge of one of the contact sheets.

### SUMMARY

In an embodiment, the present disclosure provides an energy storage cell. The energy storage cell includes an electrode-separator assembly comprising an anode, a cathode, and a separator having a sequence of anode/separator/cathode. The electrode-separator assembly is in a form of a cylindrical winding having two terminal end faces and a winding shell between the two terminal end faces. The anode is in a band shape and comprises a band shaped anode current collector comprising a first longitudinal edge, a second longitudinal edge, and two end pieces. The cathode is in a band shape and comprises a band shaped cathode current collector comprising a first longitudinal edge, a second longitudinal edge, and two end pieces. The energy storage cell also includes a housing comprising a metallic, tubular housing portion with a terminal circular opening. The electrode-separator assembly in the form of the cylindrical winding is aligned axially in the housing. The tubular housing portion comprises a central section in which the winding shell of the cylindrical winding adjoins an inner side of the tubular housing portion. The energy storage cell additionally includes an at least partly metallic contact element comprising a circular edge. The contact element is in direct contact with and connected to a respective first longitudinal edge, the respective first longitudinal edge being the first longitudinal edge of the anode current collector or the first longitudinal edge of the cathode current collector. The energy storage cell further includes an annular seal made of an electrically insulating material that surrounds the circular edge of the contact element. The anode current collector comprises a strip-shaped main region laden with a layer of negative electrode material, and a free edge strip not laden with the negative electrode material that extends along the first longitudinal edge of the anode current collector. The cathode current collector comprises a strip shaped main region laden with a layer of positive electrode material, and a free edge strip not laden with the negative electrode material that extends along the first longitudinal edge of the cathode current collector. The anode and the cathode are arranged within the electrode-separator assembly such that the first longitudinal edge of the anode current collector protrudes from a first respective terminal end face of the electrode winding and the first longitudinal edge of the cathode current collector protrudes from a second respective terminal end face of the electrode winding. The contact element together with the seal closes the terminal circular opening of the tubular housing portion. The tubular housing portion comprises a contact section in which the annular seal adjoins the inner side of the tubular housing portion. The central section of the tubular housing portion is separated from the contact section of the tubular housing portion by a depression that circularly surrounds an outer side of the tubular housing portion.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 provides cross-sectional diagrams depicting various embodiments of a contact element of an energy storage cell;

FIG. 2 provides a partial, cross-sectional diagram of an energy storage cell;

FIG. 3 provides a cross-sectional diagram of an energy storage cell;

FIG. 4 provides a cross-sectional diagram of an energy storage cell;

FIG. 5 provides a cross-sectional diagram of a contact element of an energy storage cell;

FIG. 6 provides a cross-sectional diagram of a contact element of an energy storage cell;

FIG. 7 provides a cross-sectional diagram of a contact element of an energy storage cell;

FIG. 8 provides cross-sectional diagrams visualizing the housing closure in a method;

FIG. 9 provides cross-sectional diagrams illustrating a method for producing a cell; and

FIG. 10 provides a top view illustrating weld bonds for attachment of a longitudinal seam of a current collector to a contact sheet of a contact element.

### DETAILED DESCRIPTION

The present disclosure provides energy storage cells that are notable for improved energy density compared to the prior art and homogeneous current distribution over a maximum area and length of their electrodes, and have simultaneously excellent characteristics with regard to their internal resistance and their passive cooling properties. In addition, the cells are also to feature improved producibility and safety.

According to a first aspect, an energy storage cell has the following features a. to j. immediately below:
a. The cell comprises an electrode-separator assembly having the sequence of anode/separator/cathode.
b. The electrode-separator assembly takes the form of a cylindrical winding having two terminal end faces and a winding shell in between.
c. The cell comprises a housing comprising a metallic, tubular housing portion with a terminal circular opening.
d. In the housing, the electrode-separator assembly that takes the form of a winding is aligned axially such that the winding shell adjoins the inside of the tubular housing portion.
e. The anode is band shaped and comprises a band shaped anode current collector with a first longitudinal edge and a second longitudinal edge and two end pieces.
f. The anode current collector comprises a strip-shaped main region that is laden with a layer of negative electrode material, and also a free edge strip that extends along the first longitudinal edge and is not laden with the electrode material.
g. The cathode is band shaped and comprises a band shaped cathode current collector with a first longitudinal edge and a second longitudinal edge and two end pieces.
h. The cathode current collector comprises a strip-shaped main region that is laden with a layer of positive electrode material, and also a free edge strip that extends along the first longitudinal edge and is not laden with the electrode material.
i. The anode and the cathode are arranged within the electrode-separator assembly such that the first longitudinal edge of the anode current collector protrudes from one of the terminal end faces, and the first longitudinal edge of the cathode current collector protrudes from the other of the terminal end faces.
j. The cell comprises an at least partly metallic contact element which is in direct contact with one of the first longitudinal edges and which is connected to this longitudinal edge, preferably by welding.

### CHOICE OF PREFERRED EMBODIMENTS OF THE ELECTROCHEMICAL SYSTEM

In principle, the present disclosure contemplates energy storage cells, irrespective of their electrochemical configuration. In preferred embodiments, however, the energy storage cell is a lithium ion cell, especially a secondary lithium ion cell. It is therefore possible in principle to use all electrode materials known for secondary lithium ion cells for the anode and cathode of the energy storage cell.

Active materials used in the negative electrode of an energy storage cell in the form of a lithium ion cell may be carbon-based particles such as graphitic carbon or non-graphitic carbon materials that are capable of intercalating lithium, preferably likewise in particle form. Alternatively or additionally, it is also possible for lithium titanate (Li₄Ti₅O₁₂) or a derivative thereof to be present in the negative electrode, preferably likewise in particle form. In addition, the negative electrode, as active material, may contain at least one material from the group of silicon, aluminum, tin, antimony or a compound or alloy of these materials that can reversibly intercalate and deintercalate lithium, for example silicon oxide, optionally in combination with carbon-based active materials. Tin, aluminum, antimony and silicon are able to form intermetallic phases with lithium. The capacity for absorption of lithium here, especially in the case of silicon, exceeds that of graphite or comparable materials by several times.

For the positive electrode of an energy storage cell in the form of a lithium ion cell, examples of useful active materials include lithium-metal oxide compounds and lithium-metal phosphate compounds, such as LiCoO₂ and LiFePO₄. Also highly suitable are especially lithium nickel manganese cobalt oxides (NMC) having the molecular formula LiNiₓMn_{y}Co_{z}O₂ (where x+y+z is typically 1), lithium manganese spinel (LMO) having the molecular formula LiMn₂O₄, or lithium nickel cobalt aluminum oxide (NCA) having the empirical formula LiNiₓCo_{y}Al_{z}O₂ (where x+y+z is typically 1). It is also possible to use derivatives thereof, for example lithium nickel manganese cobalt aluminum oxides (NMCA) having the empirical formula Li_{1.11}(Ni_{0.40}Mn_{0.39}Co_{0.16}Al_{0.05})_{0.89}O₂ or Li₁₊ₓM-O compounds and/or mixtures of the materials mentioned. The cathodic active materials too are preferably used in particulate form.

In addition, the electrodes of an energy storage cell in the form of a lithium ion cell preferably contain an electrode binder and/or an additive for improving electrical conductivity. The active materials are preferably embedded in a matrix of the electrode binder, wherein neighboring particles in the matrix are preferably in direct contact with one another. Conductivity agents serve to increase the electrical conductivity of the electrodes. Typical electrode binders are based, for example, on polyvinylidene fluoride (PVDF), polyacrylate or carboxymethylcellulose. Typical conductivity agents are carbon black and metal powders.

The energy storage cell preferably comprises an electrolyte, in the case of a lithium ion cell especially electrolyte based on at least one lithium salt, for example lithium hexafluorophosphate (LiPF₆) dissolved in an organic solvent (for example in a mixture of organic carbonates or a cyclic ether such as THF or a nitrile). Other usable lithium salts are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato)borate (LiBOB).

### CHOICE AND PREFERRED EMBODIMENTS OF THE SEPARATOR

The electrode-separator assembly preferably comprises at least one band shaped separator, preferably two separators in band shape, having or each having a first and a second longitudinal edge and two end pieces.

The separators are preferably formed from electrically insulating polymer films. It is preferable that the separators can be penetrated by the electrolyte. For this purpose, the polymer films used may have micropores, for example. The film may, for example, consist of a polyolefin or a polyetherketone. It is also possible to use nonwovens and weaves made of polymer materials or other electrically insulating sheetlike structures as separator. Preference is given to using separators having a thickness in the range from 5 μm to 50 μm.

In some embodiments, the separator(s) of the assembly may also be one or more layers of a solid-state electrolyte.

### Preferred Structure of the Electrode-Separator Assembly in the Form of a Winding

In the electrode-separator assembly in the form of a winding, the band shaped anode, the band shaped cathode and the band shaped separator(s) preferably take the form of a spiral winding. To produce the electrode-separator assembly, the band shaped electrodes are fed together with the band shaped separator(s) to a winding apparatus and preferably wound in a spiral around a winding axis therein. In some embodiments, the electrodes and the separator, for this purpose, are wound onto a cylindrical or hollow-cylindrical winding core which is situated on a winding mandrel and remains in the winding after the winding operation. The winding shell may, for example, be formed by a polymer film or an adhesive tape. It is also possible that the winding shell is formed by one or more separator windings.

### CHOICE AND PREFERRED EMBODIMENTS OF THE CURRENT COLLECTORS

The current collectors of the energy storage cell serve to electrically contact electrochemically active components present in the respective electrode material over a maximum area. The current collectors preferably consist of a metal or are at least superficially metallized. In the case of an energy storage cell in the form of a lithium ion cell, a suitable metal for the anode current collector is, for example, copper or nickel, or else other electrically conductive materials, especially copper alloys and nickel alloys or nickel-coated metals. Stainless steel is also useful in principle. Suitable metals for the cathode current collector in the case of an energy storage cell in the form of a lithium ion cell are especially aluminum or else other electrically conductive materials, including aluminum alloys.

The anode current collector and or the cathode current collector are preferably each a metal foil having a thickness in the range from 4 μm to 30 μm, especially a band shaped metal foil having a thickness in the range from 4 μm to 30 μm.

As well as foils, however, current collectors used may also be other band shaped substrates, such as metallic or metallized nonwovens or open-pore metallic foams or expanded metals.

The current collectors are preferably laden on either side with the respective electrode material.

It is preferable that the longitudinal edges of the separator(s) form the end faces of the electrode-separator assembly in the form of a winding.

It is further preferable that the longitudinal edges or edges of the anode current collector and/or of the cathode current collector that protrudes from the terminal end faces of the winding or sides of the stack project by not more than 5000 μm, preferably not more than 3500 μm, from the end faces or sides.

More preferably, the edge or longitudinal edge of the anode current collector projects from the side of the stack or end face of the winding by not more than 2500 μm, more preferably not more than 1500 μm. More preferably, the edge or longitudinal edge of the cathode current collector projects from the side of the stack or end face of the winding by not more than 3500 μm, more preferably not more than 2500 μm.

### Inventive Solution

Particular features of the energy storage cell are the three following features k., l. and m.:
k. The contact element comprises a circular edge.
l. The cell comprises an annular seal made of an electrically insulating material that surrounds the circular edge of the contact element.
m. The contact element together with the seal closes the terminal circular opening of the tubular housing portion.

What is thus proposed is the use, as contact element, of one having a circular edge, the pulling of an annular seal made of an electrically insulating material onto the circular edge of the contact element, and the closure of the terminal circular opening of the tubular housing portion by the contact element. The contact element that serves not just for electrical contacting of an electrode; instead, it also simultaneously functions as housing portion. This is associated with a major advantage, in that a separate electoral connection between the contact element and the housing portion is no longer required. This creates space within the housing and simplifies cell-assembly. Moreover, direct attachment of a housing portion to the current collectors of a cell imparts excellent cooling properties thereto.

The contact element is preferably a contact sheet in the shape of a disk. More preferably, the contact sheet in the shape of a disk either has a single-layer edge that extends in a radially outward direction, or the edge is bent inward, so as to result in a double-layer edge region with a U-shaped cross section.

### PREFERRED EMBODIMENTS OF THE CONTACT ELEMENT/ELECTRICAL ATTACHMENT OF THE CONTACT ELEMENT TO THE ELECTRODE-SEPARATOR ASSEMBLY IN THE FORM OF A WINDING

In a first variant, the energy storage cell has at least one of the four features a. to d. immediately below:
a. The contact element is or comprises a metal disk, the edge of which corresponds to or forms part of the circular edge of the contact element.
b. The contact element, especially the metal disk, is arranged in the tubular housing portion such that the annular seal runs along a circumferential contact zone on the inside of the tubular housing portion.
c. The annular seal is in compressed form in the contact zone as a consequence of a pressure which is exerted thereon by the edge of the contact element, especially the edge of the metal disk, and the inside of the tubular housing portion.
d. One of the first longitudinal edges directly adjoins the contact element, especially directly adjoins the metal disk, and is preferably bonded to the contact element, especially to said method disk, by welding.

Particular preference is given to implementation of features a., b. and d. immediately above in combination. In one development, all four features a. to d. immediately above are implemented in combination with one another.

In the simplest embodiment, the metal disk is a flat piece of sheet metal with a circular circumference that extends in just one plane. In many cases, however, more complex forms may also be preferred. Thus, the metal disk may be profiled, for example may have one or more circular depressions and/or elevations, preferably in a concentric arrangement, about its center, which may result, for example, in a corrugated cross section. It is also possible that the inside thereof has one or more lands. In addition, the disk may have an edge bent radially inward, such that it has a double-layer edge region with, for example, U-shaped cross section.

The contact element may consist of multiple individual parts, including the metal disk, which need not necessarily all consist of metal. In a preferred embodiment, the contact element may comprise, for example, a profiled metal terminal cover with circular circumference, which may be welded onto the metal disk and has approximately or exactly the same diameter as the metal disk, such that the edge of the metal disk and the edge of the terminal cover collectively form the edge of the contact element. In a further embodiment, the edge of the terminal cover may be surrounded by the edge of the metal disk mentioned that has been bent radially inward. In preferred embodiments, a clamp connection may even exist between the two individual parts.

In order that the annular seal can run along the circumferential contact zone on the inside, it is preferable that the tubular housing portion has a circular cross section at least in the region in which the seal adjoins it. Appropriately, the region is in hollow cylindrical form for this purpose. The internal diameter of the tubular housing portion in this region is matched correspondingly to the external diameter of the edge of the contact element, especially to the external diameter of the metal disk with the seal pulled onto it.

The compression of the seal in the contact zone is a feature with no counterpart in the prior art discussed at the outset. While the seal in the cell described in U.S. Pat. No. 6,432,574 B1 is compressed above and below an edge of a cover, the compressed seal region currently being described preferably runs concentrically around the cover edge.

The seal itself may be a customary polymer seal that should be chemically resistant to the electrolyte used in each case. The person skilled in the art is aware of suitable seal materials.

The concept of the welding of the edges of current collectors to contact elements is already known from WO 2017/215900 A1 or from JP 2004-119330 A. This technology enables particularly high current durabilities and low internal resistance. With regard to methods of electrical connection of contact elements, especially also of disk-shaped contact elements, with the edges of current collectors, reference is therefore made completely to the content of WO 2017/215900 A1 and of JP 2004-119330 A.

Especially with regard to the welding of the metal disk to the longitudinal edge of the current collector, which offers a fundamentally more reliable electrical connection than, for example, a mere press-fit contact, it is particularly preferable that the metal disk has at least one of the features a. and b. immediately below:
a. The metal disk used preferably has a thickness in the range from 50 μm to 600 μm, preferably in the range from 150 μm to 350 μm.
b. The metal disk consists of alloyed or unalloyed aluminum, alloyed or unalloyed titanium, alloyed or unalloyed nickel or alloyed or unalloyed copper, but optionally also of stainless steel (for example of the 1.4303 or 1.4404 type) or of nickel-plated steel.

It is particularly preferable when features a. and b. immediately above are implemented in combination.

When the longitudinal edge that directly adjoins the metal disk is the anode current collector, the anode current collector and the metal disk, especially the metal disk welded thereto, preferably both consist of the same or at least of a chemically related material, for example of copper and a copper alloy. In the case of an energy storage cell in the form of a lithium ion cell, it is preferably chosen from the group comprising copper, nickel, titanium, alloys of these three elements, nickel-plated steel and stainless steel. In the case of a lithium titanate anode, the anode current collector and/or the metal disk may also consist of aluminum.

When the longitudinal edge that directly adjoins the metal disk is the cathode current collector, the cathode current collector and the metal disk, especially the metal disk welded thereto, preferably both consist of the same or at least of a chemically related material, for example of aluminum and of an aluminum alloy. This is more preferably selected from the group comprising alloyed or unalloyed aluminum, titanium, titanium alloys and stainless steel (for example of the 1.4404 type).

More preferably, one of the first longitudinal edges directly adjoins the metal disk in terms of its length. This results in a linear contact zone which, in the case of the spiral-wound electrodes, has a spiral progression. It is preferable that there is very uniform attachment of the longitudinal edge to the metal disk along this linear and preferably spiral contact zone by means of suitable weld bonds. More preferably, this attachment may be configured as follows:
The longitudinal edge of the current collector directly adjoining the metal disk is continuously bonded to the metal disk via a weld seam over its entire length.
The longitudinal edge of the current collector directly adjoining the metal disk comprises one or more sections that are each continuously connected to the metal disk via a weld seam over their entire length. More preferably, these sections have a minimum length of 5 mm, preferably of 10 mm, more preferably of 20 mm.
The longitudinal edge of the current collector directly adjoining the metal disk is connected to the metal disk via a multitude of spot weld bonds (called a multi-pin bond).

Among these three contacting variants, it is of course also possible to combine the second and third with one another.

In one possible development of the second contacting variant, the section(s) bonded to the metal disk over their entire length extend over at least 25%, preferably over at least 50%, more preferably about the 75%, of the total length of the respective longitudinal edge.

In a second variant, the energy storage cell has at least one of the five features a. to e. immediately below:
a. The contact element comprises a metal disk, the edge of which corresponds to or forms part of the circular edge of the contact element.
b. The metal disk is arranged in the tubular housing portion such that the annular seal runs along a circumferential contact zone on the inside of the tubular housing portion.
c. The annular seal is in compressed form in the contact zone as a consequence of a pressure which is exerted thereon by the edge of the metal disk and the inside of the tubular housing portion.
d. The contact element comprises a metallic contact sheet having two sides, one facing in the direction of the metal disk and preferably bonded to the metal disk by welding.
e. One of the first longitudinal edges directly adjoins the other side of the contact sheet and is bonded thereto, preferably by welding.

Particular preference is given to implementation of features a., b., c. and d. immediately above in combination. In one development, all five features a. to e. immediately above are implemented in combination with one another.

With regard to some features, the second variant does not differ from the first, for instance within the scope of features b. and c., which must thus also be no longer executed separately. By contrast with the first variant, the contact element, as well as the metal disk, however, comprises a contact sheet as further component, in which case one of the first longitudinal edges does not directly adjoin the metal disk, but instead directly adjoins the contact sheet. The metal disk serves to close the housing, while the contact sheet makes contact with the longitudinal edge of the current collector. The longitudinal edge is preferably attached here to the contact sheet in accordance with one of the three contacting variants described above.

The contact sheet, from a physical point of view, is preferably formed in the same way as the metal disk in the first variant. As it were, it preferably consists of the same material as the adjoining current collector or of a chemically related material. It preferably has a thickness of 50 μm to 600 μm, preferably in the range from 150 μm to 350 μm.

In a simple embodiment, the contact sheet is a two-dimensional sheet metal component that extends in just one plane; in other embodiments, it may also be a profiled sheet metal component. In particular, it is also possible that it has one or more lands or elongated depressions on the side in contact with the longitudinal edge.

The contact sheet may have a circular circumference, but this is in no way an absolute requirement. In some cases, the contact sheet may, for example, be a metal strip or have multiple segments in strip form that exist, for example, in a star-shaped arrangement.

In some embodiments, it is possible to use a contact sheet having at least one slot and/or at least one perforation. These may serve to counteract deformation of the contact sheet in the production of a weld bond with the first longitudinal edge.

The side of the contact sheet facing the metal disk preferably takes such a form that there is a two-dimensional contact area in the case of direct contact of the contact sheet with the metal disk, i.e. the contact sheet and the metal disk lie flat against one another at least in some regions. Preference is given to existence of this direct contact and the two-dimensional contact surface.

The metal disk is preferably formed so as to be complementary thereto. It preferably likewise has a thickness in the range from 50 μm to 600 μm. When combined with the contact sheet, it may consist of stainless steel, for example of the 1.4303 or 1.4404 type.

The contact sheet and the metal disk are preferably in rigid contact, further preferably in rigid direct contact, with one another. In this case, they are more preferably fixed to one another by welding or soldering.

In preferred embodiments, the contact sheet is designed like the contact plates described in WO 2017/215900 A1.

### Closure of the Terminal Circular Opening—Preferred Configurations

More preferably, the energy storage cell, especially in the described embodiments of the first and second variants, has at least one of the two additional features a. and b. immediately below:
a. The tubular housing portion, in axial direction, comprises a central section in which the winding shell adjoins the inside thereof, and a contact section in which the annular seal adjoins the inside thereof, wherein
   The tubular housing portion has a constant internal diameter in and between the two sections and/or
   The central section is separated from the contact section by a depression which circularly surrounds the outside of the tubular housing portion.
b. In the region of the circumferential depression, the external diameter of the tubular housing portion is reduced by not more than 2 to 6 times the wall thickness of the housing in said region.

It is particularly preferable that the depression separates the central section from the contact section.

In accordance with the above remarks relating to the preferred configuration of the tubular housing portion in the region of the contact zone, the contact section is preferably cylindrical or, more precisely, hollow-cylindrical. The same applies with regard to the configuration of the central section.

The depression mentioned is preferably a circumferential bead that can occur as a result of the production, but, unlike the groove introduced into the housing in the case of conventional cells (see above remarks relating to WO 2017/215900 A1), is in no way a prerequisite for closure of the housing. It is therefore preferably also much less deep than the groove described. In the ideal case, the bead is so insignificant that its presence has no effect on the internal diameter of the tubular housing portion, such that it is constant from the central section as far as the contact section. This has the significant advantage that the dead volume resulting from the groove has no counterpart and the central section can move closer to the contact section. In other words, it is possible to install higher windings composed of electrodes and separators and hence to increase the energy density of the energy storage cells. Especially in combination with the features of the above-described first variant, a further advantage is that it is possible to dispense with a separate current conductor to cover the distance between the winding and a housing cover.

In some embodiments, it is further preferable that the energy storage cell has at least one of the two additional features a. and b. immediately below:
a. The tubular housing portion comprises a circular edge which is bent radially inward about the edge of the contact element which is surrounded by the seal and which fixes the contact element in the circular opening of the tubular housing portion.
b. The contact section extends in axial direction from the depression up to the edge bent radially inward.

While feature a. is a preferred development for all embodiments described above, feature b. is relevant only for the cases in which the bead described occurs.

Housing Variant with Housing Cup

In a preferred embodiment, the energy storage cell has at least one of the additional features a. and b. immediately below:
a. The tubular housing portion is part of a housing cup comprising a circular base.
b. The other of the first longitudinal edges directly adjoins the base and is bonded to the base, preferably by welding.

Particular preference is given to implementation of features a. and b. immediately above in combination.

The use of housing cups has long been known in the building of cell housings, for instance from WO 2017/215900 A1 that was cited at the outset. What is not known, by contrast, is the direct attachment of the longitudinal edges of a current collector to the base of a housing cup, as proposed here. This measure makes it possible to dispense with a separate electrical conductor, now on the base side, and to use an axially extended wound electrode-separator assembly, and hence contributes to an increase in the energy density of the cell and to an improvement in the cooling properties thereof.

According to the disclosure, it is thus possible and preferable to couple the current collector edges of the positive and negative electrodes that protrude from opposite end faces of an electrode-separator assembly in the form of a winding each directly to a housing portion, namely the base of the cup and the above-described contact element that functions as closure element. The use of the available internal volume of the cell housing for active components thus approaches its theoretical optimum.

The coupling of the other of the first longitudinal edges to the base fundamentally follows the same construction principles as in the case of the contact element. Here too, the longitudinal edge preferably directly adjoins the base in terms of its length, so as to result in a linear contact zone having a spiral progression in the case of the spiral-wound electrodes. Here too, it is further preferable that there is very uniform attachment of longitudinal edge to the metal disk along this linear and preferably spiral contact zone by means of suitable weld bonds. This attachment is preferably configured in accordance with one of the three above-described contacting variants or a combination of these contacting variants, i.e., for example, as a multi-pin bond.

The housing cup, especially in the region of its base, preferably has a similar thickness to the above-described metal disk, i.e., in particular, a thickness in the range from 50 μm to 600 μm, preferably in the range from 150 μm to 350 μm.

Especially when the cell is configured as a lithium ion cell, the choice of material from which the housing cap is manufactured depends on whether the anode current collector or cathode current collector is attached to the base. Suitable materials are in principle the same from which the current collectors themselves are manufactured. The materials mentioned above for the metal disk are also useful.

In principle, it is also possible that—as in the case of the contact element—there is merely an indirect connection via a contact sheet between the longitudinal edge of the other of the first longitudinal edges and the base of the cup. In this case, there is preferably a weld bond between the longitudinal edge and the contact sheet according to one of the three above-described contacting variants, while the contact sheet is preferably bonded by direct welding to the base. The contact sheet is preferably configured like its counterpart in the case of the contact element described.

Housing Variant with Two Covers

In a further preferred embodiment, the energy storage cell has at least one of the three additional features a. to c. immediately below:
a. The tubular housing portion has a further terminal circular opening.
b. The cell comprises a closure element having a circular edge that closes this further terminal opening.
c. The closure element for the further terminal opening is or comprises a metal disk, the edge of which corresponds to or forms part of the circular edge of the metallic closure element.

Particular preference is given to implementation of features a. to c. immediately above in combination.

In this embodiment, the tubular housing portion replaces a housing cup together with a closure element. The housing is thus composed of three housing portions, one of which is tubular, and the other two (the contact element and the closure element) close the terminal openings of the tubular portion as a cover. In terms of production, this offers advantages since no deep drawing tools are required for the production of tubular housing portions, unlike in the case of housing cups. In the case of direct attachment of the other of the first longitudinal edges to the closure element, this fundamentally results in the same advantages as in the above-described attachment to the base of a housing cup.

The tubular housing portion in this embodiment is preferably cylindrical or hollow cylindrical. The closure element, in analogy to the above-described contact element, in the simplest embodiment is a metal disk having a circular circumference, for example a metal disk that extends in just one plane, or alternatively a profiled metal disk having, for example, one or more circular depressions and/or elevations about its center, preferably in a concentric arrangement, which can result, for example, in a corrugated cross section. Likewise preferably, the inside of the closure element, especially of the metal disk, may have one or more lands. In addition, the closure element, especially the metal disk, may also have an edge bent radially inward, such that it has a double-layer edge region with, for example, U-shaped cross section.

More preferably, the contact element is a disk-shaped contact sheet. More preferably, the contact sheet in the shape of a disk either has a single-layer edge that extends in a radially outward direction, or the edge is bent inward, so as to result in a double-layer edge region with a U-shaped cross section.

In the choice of material and of the preferred thickness of the closure element, especially of the metal disk, it is likewise possible to refer to the above remarks relating to the metal disk of the closure element. The preferred features specified therein are also applicable to the closure element.

In a development of this preferred embodiment, the energy storage cell has at least one of the features a. to c. immediately below:
a. The metal disk is arranged in the tubular housing portion such that the edge thereof runs along a circumferential contact zone on the inside of the tubular housing portion.
b. The edge of the metal disk is joined to the tubular housing portion via a circumferential weld seam.
c. The tubular housing portion comprises a circular edge bent radially inward about the edge of the closure element, especially the edge of the metal disk.

More preferably, features a. and b. immediately above, and if appropriate also features a. to c. immediately above, are implemented in combination.

In this development, it is thus preferable to fix the closure element by welding in the further terminal opening. There is no need for a separate sealing element in the case of a circumferential weld seam.

The radial bending-over of the edge of the closure element is an optional measure that is not required for fixing of the closure element, but may nevertheless be appropriate.

In one development, the energy storage cell has one of the features a. to c. immediately below:
a. The other of the first longitudinal edges directly adjoins the metal disk and is joined to the metal disk, preferably by welding.
b. The other of the first longitudinal edges is welded to a contact sheet that directly adjoins the metal disk

In principle, it is also possible here that—as in the case of the contact element—there is merely an indirect connection via a contact sheet between the longitudinal edge of the other of the first longitudinal edges and the metal disk or closure element. In this case, there is preferably a connection by direct welding between the contact sheet and the closure element, especially the metal disk. The contact sheet is preferably configured like its counterpart in the case of the contact element described. In particular, a side of the contact sheet facing the metal disk is in direct contact with the metal disk, such that there is a two-dimensional contact surface, i.e. the contact sheet and the metal disk lie flat against one another at least in some regions.

For the coupling of the other of the first longitudinal edges to the metal disk of the closure element or to the contact sheet, the same preferred embodiments are applicable that are also applicable to the above-described attachments of the longitudinal edges to the base of the cup and to the contact element. For avoidance of repetition, reference is made to the corresponding remarks in this regard (linear contact zone with a preferably spiral progression, maximum uniformity of attachment of the longitudinal edge to the metal disk along this linear contact zone by means of suitable weld bonds).

The metal disk of the closure element preferably has a similar thickness to the metal disk of the contact element, i.e., in particular, a thickness in the range from 50 μm to 600 μm, preferably in the range from 150 μm to 350 μm.

Especially when the cell is configured as a lithium ion cell, the choice of material from which the metal disk of the closure element is manufactured depends on whether the anode current collector or cathode current collector is attached to the closure element. Suitable materials are in principle the same from which the current collectors themselves are manufactured. The materials mentioned above for the metal disk of the contact element are also useful.

Housing Variant with Two Electrically Insulated Covers

In a further preferred embodiment, the energy storage cell has at least one of the four additional features a. to d. immediately below:
a. The cell comprises an annular seal made of an electrically insulating material that surrounds the circular edge of the closure element, especially the edge of the metal disk.
b. The metal disk is arranged in the tubular housing portion such that the annular seal runs along a circumferential contact zone on the inside of the tubular housing portion.
c. The annular seal is in compressed form in the contact zone as a consequence of a pressure which is exerted thereon by the edge of the metal disk and the inside of the tubular housing portion.
d. The tubular housing portion comprises a circular edge which is bent radially inward about the edge of the closure element which is surrounded by the seal and which fixes the closure element in the further terminal opening of the tubular housing segment.

More preferably, the three features a. to c. immediately above, and if appropriate also the four features a. to d. immediately above, are implemented in combination.

In one development, the energy storage cell preferably has one of the features a. and b. immediately below:
a. The other of the first longitudinal edges directly adjoins the metal disk and is joined to the metal disk by welding.
b. The other of the first longitudinal edges is welded to a contact sheet that directly adjoins the metal disk.

In these embodiments too, the tubular housing portion replaces a housing cup together with a closure element. The housing here too thus consists of three housing portions, one of which is tubular, and the other two (the contact element and the closure element) close the terminal openings of the tubular portion as cover. However, the contact element and the closure element here are electrically insulated from the tubular housing portion. The contact element and the closure element form the terminals of the cell.

With regard to the configuration of the closure element, reference may be made to the above remarks relating to the contact element. All preferred embodiments that apply to the contact element are also applicable to the closure element. In preferred embodiments, the closure element and the contact element are executed in a mirror-symmetrical manner with respect to one another, if appropriate apart from the metallic material chosen in each case, which is generally chosen depending on the respective polarity.

For the coupling of the other of the first longitudinal edges to the metal disk of the closure element or to the contact sheet, the same preferred embodiments are applicable that are also applicable to the above-described attachments of the longitudinal edges to the base of the cup and to the contact element. For avoidance of repetition, reference is made here too to the corresponding remarks in this regard (linear contact zone with a preferably spiral progression, maximum uniformity of attachment of the longitudinal edge to the metal disk along this linear contact zone by means of suitable weld bonds).

### Preferred Configurations of the Electrodes

In the free edge strip, the metal of the respective current collector is preferably free of the respective electrode material. In some preferred embodiments, the metal of the respective current collector is uncovered there, such that it is available for electrical contact connection, for example by welding.

In some further embodiments, the metal of the respective current collector, in the free edge strips, may alternatively be coated at least in some regions with a support material which is of greater thermal stability than the current collector coated therewith and which differs from the electrode material disposed on the respective current collector.

What is meant here by “of greater thermal stability” is that the support material retains its solid state at a temperature at which the metal of the current collector melts. It thus either has a higher melting point than the metal or else it sublimes or breaks down only at a temperature at which the metal has already melted.

The support material may in principle be a metal or a metal alloy if it has a higher melting point than the metal of which the surface coated with the support material consists. In many embodiments, however, the energy storage cell preferably has at least one of additional features a. to d. immediately below:
a. The support material is a nonmetallic material.
b. The support material is an electrically insulating material.
c. The nonmetallic material is a ceramic material, a glass-ceramic material or a glass.
d. The ceramic material is aluminum oxide (Al₂O₃), titanium oxide (TiO₂), titanium nitride (TiN), titanium aluminum nitride (TiAlN), a silicon oxide, especially silicon dioxide (SiO₂), or titanium carbonitride (TiCN).

According to the disclosure, the support material is more preferably according to feature b. immediately above, and is especially preferably according to feature d. immediately above.

The term “nonmetallic material” especially encompasses plastics, glasses and ceramic materials.

The term “electrically insulating material” in the present context should be interpreted broadly. In principle, it encompasses any electrically insulating material, especially including said polymers.

The term “ceramic material” in the present context should be interpreted broadly. In particular, this is understood to mean carbides, nitrides, oxides, silicides or mixtures and derivatives of these compounds.

The term “glass-ceramic material” especially means a material comprising crystalline particles embedded into an amorphous glass phase.

The term “glass” in principle means any inorganic glass that meets the above-defined criteria for thermal stability and is chemically stable with respect to any electrolyte present in the cell.

More preferably, the anode current collector consists of copper or a copper alloy, while the cathode current collector simultaneously consists of aluminum or an aluminum alloy, and the support material is aluminum oxide or titanium oxide.

It may further be preferable that the free edge strip of the anode current collector and/or cathode current collector is coated with a strip of the support material.

The main regions, especially the strip shaped main regions of anode current collector and cathode current collector, preferably extend parallel to the respective edges or longitudinal edges of the current collectors. Preferably, the strip shaped main regions extend over at least 90%, more preferably over at least 95%, of the areas of anode current collector and cathode current collector.

In some preferred embodiments, the support material is applied in the form of a strip or a line immediately alongside the main regions that are preferably strip shaped, but does not fully cover the exposed regions, such that the metal of the respective current collector is exposed immediately along the longitudinal edge.

### Other Preferred Configurations of the Energy Storage Cell

The energy storage cell may be a button cell. Button cells are cylindrical and have a height that is less than their diameter. The height is preferably within a range from 4 mm to 15 mm. It is further preferable that the button cell has a diameter within a range from 5 mm to 25 mm. Button cells are suitable, for example, for supplying electrical energy to small electronic devices such as watches, hearing aids, and wireless headphones.

The nominal capacity of a button cell in the form of a lithium ion cell is generally up to 1500 mAh. The nominal capacity is preferably within a range from 100 mAh to 1000 mAh, more preferably within a range from 100 to 800 mAh.

More preferably, however, the energy storage cell is a cylindrical round cell. Cylindrical round cells have a height that is greater than their diameter. They are especially suitable for the applications cited at the outset with a high energy demand, for example in the automotive sector or for E-bikes or for power tools.

The height of energy storage cells in the form of a round cell is preferably within a range from 15 mm to 150 mm. The diameter of the cylindrical round cells is preferably within a range from 10 mm to 60 mm. Within these ranges, shape factors of, for example, 18×65 (diameter×height in mm) or 21×70 (diameter×height in mm) are preferred. Cylindrical round cells having these shape factors are particularly suitable for powering electric drives in motor vehicles.

The nominal capacity of the cylindrical round cell in the form of a lithium ion cell is preferably up to 90 000 mAh. With the shape factor of 21×70, the cell in one embodiment as a lithium-ion cell preferably has a nominal capacity within a range from 1500 mAh to 7000 mAh, more preferably within a range from 3000 to 5500 mAh. With the shape factor of 18×65, the cell in one embodiment as a lithium-ion cell preferably has a nominal capacity within a range from 1000 mAh to 5000 mAh, more preferably within a range from 2000 to 4000 mAh.

In the European Union, manufacturer information on the nominal capacities of secondary batteries is strictly regulated. For instance, information on the nominal capacity of secondary nickel-cadmium batteries is based on measurements in accordance with standards IEC/EN 61951-1 and IEC/EN 60622, information on the nominal capacity of secondary nickel-metal hydride batteries on measurements in accordance with standard IEC/EN 61951-2, information on the nominal capacity of lithium secondary batteries on measurements in accordance with standard IEC/EN 61960, and information on the nominal capacity of lead-acid secondary batteries on measurements in accordance with standard IEC/EN 61056-1. Any figures for nominal capacities in the present application are preferably likewise based on these standards.

The anode current collector, the cathode current collector and the separator, in embodiments in which the cell is a cylindrical round cell, are preferably band shaped and preferably have the following dimensions:
a length in the range from 0.5 m to 25 m a width in the range from 30 mm to 145 mm
The free edge strip that extends along the first longitudinal edge and is not laden with the electrode material in these cases preferably has a width of not more than 5000 μm.

In the case of a cylindrical round cell having the shape factor 18×65, the current collectors preferably have
a width of 56 mm to 62 mm, preferably of 60 mm, and
a length of not more than 1.5 m.

In the case of a cylindrical round cell having the shape factor 21×70, the current collectors preferably have
a width of 56 mm to 68 mm, preferably of 65 mm, and
a length of not more than 2.5 m.

### Production Method

According to a second aspect, a method for producing an energy storage cell includes the following steps:
a. providing an electrode-separator assembly having the sequence of anode/separator/cathode, in the form of a cylindrical winding with two terminal end faces and a winding shell in between, wherein the electrodes each have a current collector coated with an electrode material and having a first longitudinal edge and a second longitudinal edge and two end pieces, and one of the longitudinal edges of one of the electrodes protrudes from one of the terminal end faces:
   In this step, an electrode-separator assembly is provided as described above. Reference is made to the above remarks.
b. Providing a tubular housing portion having a terminal circular opening:

With regard to possible configurations of this portion, reference is likewise made to the above remarks relating to the cell according to the first aspect.
c. Providing an at least partly metallic contact element having a circular edge:

At this point too, reference is made to the description of the contact element with regard to the cell according to the first aspect.
d. Applying an annular seal to the circular edge of the contact element.
e. Welding the longitudinal edge that protrudes from the end face to the contact element or a metallic component of the contact element:

The metallic component of the contact element is especially the above-described contact sheet. The welding can be effected, for example, by means of a laser. The longitudinal edge is preferably attached here to the contact sheet in accordance with one of the three contacting variants described above.
f. Pushing the electrode-separator assembly through the circular opening into the tubular housing portion, such that the winding shell adjoins the inside of the tubular housing portion and the annular seal applied to the edge of the contact element runs along a circumferential contact zone on the inside of the tubular housing portion.
g. Exerting a radially directed pressure on the tubular housing portion, such that the inside thereof is pressed against the edge of the contact element and the annular seal disposed in between is subjected to a pressure and compressed.

The steps detailed need not necessarily be implemented in the sequence specified. For example, it is possible to switch the sequence of steps d., e. and f.

In a preferred embodiment, the method additionally has at least one of the steps immediately below and/or one of the features immediately below:
a. The tubular housing portion in axial direction comprises an essentially cylindrical central section, a terminal section that extends up to a circular opening edge, and optionally a transition region in between.
b. The transition region between the cylindrical central section and the terminal section consists in a widening of the internal diameter of the tubular housing portion in the form of a step.
c. The terminal section, proceeding from the widening in the form of a step, has a rising internal diameter in the direction of the circular opening edge.
d. The contact element with the annular seal applied to the edge thereof has an external diameter less than an internal diameter of the tubular housing portion in the terminal section, and greater than the internal diameter of the tubular housing portion in the cylindrical central section.
e. The electrode-separator assembly is inserted into the tubular housing portion to such an extent that the contact element rests on the widening in the form of a step.

More preferably, the steps and/or features a. and b., and d. and e., immediately above are combined with one another in one embodiment; and often also the steps and/or features a. to e. immediately above.

In addition, the method, in preferred embodiments, features at least one of features a. and b. immediately below:
a. After the electrode-separator assembly has been inserted, the external diameter of the terminal section is matched to the external diameter of the cylindrical central section by radially indenting the transition region and compressing the seal.
b. After the external diameter of the terminal section has been matched, the opening edge of the terminal section is bent radially inward about the edge of the contact element surrounded by the seal.

Particular preference is given to implementation of steps a. and b. immediately above in combination.

The transition region that is radially indented in this embodiment is the extension in the form of a step. This operation can result in the above-described bead.

In addition, the method, in preferred embodiments, features at least one of the three features a. to c. immediately below:
a. The electrode-separator assembly is impregnated with an electrolyte, wherein the electrolyte is introduced through an aperture intended for the purpose in the contact element or another housing portion.
b. After the electrolyte has been introduced impregnated, the aperture is closed, for example by bonding or welding.
c. The closure is effected using a pressure relief device.

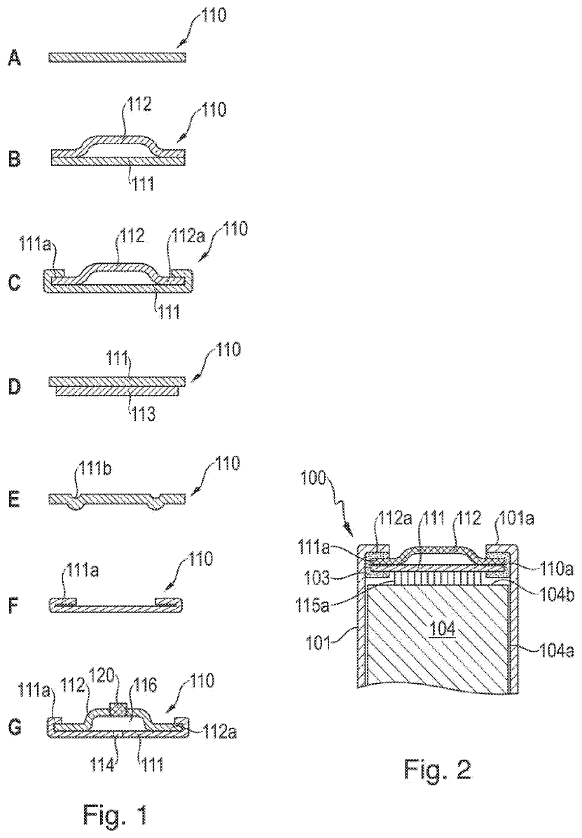

FIG. 1 shows cross-sectional diagrams of various embodiments of contact elements 110 that are suitable for closure of inventive energy storage cells 100. Specifically:

A What is shown here is the simplest embodiment of a contact element 110, namely a flat metal disk with a round circular circumference that extends only on one plane. The metal disk may consist, for example, of aluminum. The edge of the metal disk extends in a radially outward direction.

B The contact element 110 shown here comprises the metal disk 111 and the terminal cover 112. The metal disk 111 and the terminal cover 112 each have a circular circumference and an identical diameter. While the metal disk 111 extends only on one plane, the terminal cover 112 has a central concavity. The two parts 111 and 112 of the contact element 110 are preferably bonded to one another by a weld (not shown). The double-layer edge of the contact element 110 extends in a radially outward direction.

C The contact element 110 shown here comprises the metal disk 111 and the terminal cover 112. The terminal cover 112 is analogous to the terminal cover in B. However, the edge 111a of the metal disk 111 is bent radially inward here, such that the metal disk 111 has a U-shaped cross section in the edge region. The bent-over edge 111a surrounds the edge 112a of the terminal cover 112, and hence fixes the terminal cover 112 on the metal disk 111. Regardless of that, it is preferable when the metal disk 111 and the terminal cover 112 are additionally welded to one another.

D The contact element 110 shown here comprises the metal disk 111 and the contact sheet 113. The contact sheet 113 lies flat on the metal disk 111 and is preferably welded thereto. The metal disk 111 may consist, for example, of stainless steel, and the contact sheet 113, for example, of an aluminum alloy. The edge of the contact element 110 extends in a radially outward direction.

E The contact element 110 shown here comprises solely a metal disk. By contrast with the metal disk shown in A, this has a circular depression 111b on its upper face, and a corresponding elevation on its lower face, i.e. is profiled. The edge of the contact element 110 extends in a radially outward direction.

F The contact element 110 shown here comprises solely a metal disk. By contrast with the metal disk shown in A, this has an edge 111a turned over radially inward, and as a result a double-layer edge region. The double-layer edge region has a U-shaped cross section.

G The contact element 110 shown here comprises the metal disk 111 and the terminal cover 112 that has a central concavity. The edge 111a of the metal disk 111 is bent radially inward here, such that the metal disk 111 has a U-shaped cross section in the edge region. The bent-over edge 111a surrounds the edge 112a of the terminal cover 112, and hence fixes the terminal cover 112 on the metal disk 111. The edges 111a and 112a of the metal disk 111 and the terminal cover 112 have preferably additionally been bonded to one another by a circumferential weld (not shown). In the center of the metal disk 111 is the hole 114 via which a cavity 116 is accessible, enclosed by the metal disk 111 and the terminal cover 112. Integrated into the terminal cover 112 is a pressure relief device 120 which can be triggered in the event of an excess pressure in the cavity 116. The pressure relief device 120 in the simplest case may be an intended breakage site.

The energy storage cell 100 shown in FIG. 2 features the contact element 110 shown in FIG. 1B, the edge 110a of which is formed by the edges 111a and 112a of the metal disk 111 and of the terminal cover 112, and which is surrounded by the annular seal 103 consisting of an electrically insulating plastic. The contact element 110 together with the hollow cylindrical housing portion 101 forms the housing of the energy storage cell 100 and closes one of the terminal openings thereof. The edge 101a of the housing portion 101 is bent radially inward about the edge 110a of the contact element 100 which is surrounded by the seal 103 and which fixes the contact element 110 in the circular opening of the tubular housing portion 101. In the housing, the spiral-wound electrode-separator assembly 104 is aligned axially such that its winding shell 104a adjoins the inside of the tubular housing portion 101. The longitudinal edge 115a of the anode current collector protrudes from the upper end face 104b of the electrode-separator assembly 104 in the form of a winding. This is welded directly onto the underside of the metal disk 111, for example via a multi-pin bond.

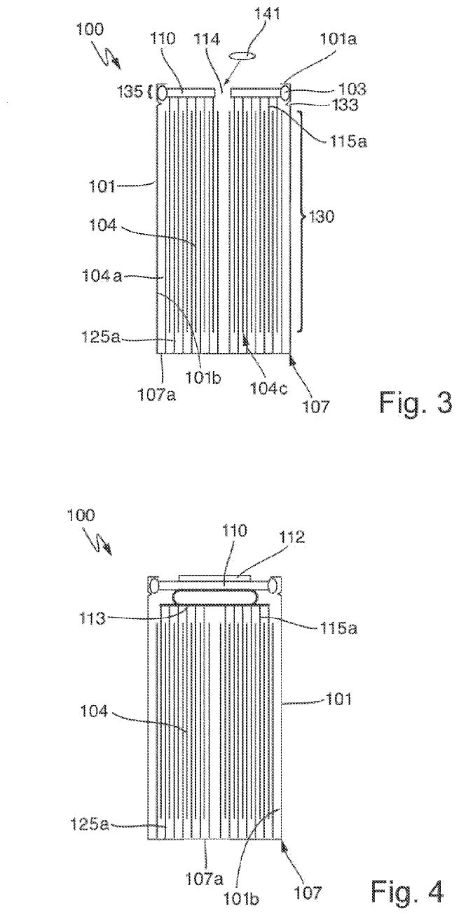

The energy storage cell 100 shown in FIG. 3 is an example of the above-described housing variant with a housing cup. The housing portion 101, which is hollow cylindrical here too, is part of the housing cup 107 comprising a circular base 107a. The housing cup 107 together with the contact element 110, which is a flat metal disk having a central hole 114, includes an interior in which the electorate-separator assembly 104 in the form of a winding is axially aligned. After an electrolyte has been introduced into the housing, the hole 114 is closed by means of the sheet metal disk 141. It could of course also have been introduced into the base 107a of the housing. The housing portion 101 and hence the housing cup 101 are electrically separated from the contact element 110 by the seal 103. The edge 101a of the housing portion 101 is bent radially inward about the edge of the contact element 110 which is surrounded by the seal 103 and which fixes the contact element 110 in the circular opening of the tubular housing portion 101. The tubular housing portion 101, in axial direction, comprises a central section 130 in which the winding shell 104a adjoins the inside thereof 101b, and a contact section 135 in which the annular seal 103 adjoins the inside thereof 101b. The annular seal 103 is in compressed form in the contact section 135 as a consequence of a pressure which is exerted thereon by the edge of the contact element 110 and the inside 101b of the tubular housing portion 101.

The two sections 130 and 135 are separated from one another by the circumferential bead 133. The bead 133 is not very pronounced and projects by not more than one housing wall thickness into the interior on the inside 101b of the housing portion 101, specifically where the longitudinal edge 115a of the anode current collector protrudes from the end face 104b of the winding. Said winding is welded directly onto the inside of the contact element 110. At the bottom face, the longitudinal edge 125a of the cathode current collector welded directly onto the inside of the base 107a emerges from the bottom end face 104c of the electrode-separator assembly 104 in the form of a winding. The utilization of space within the housing in this embodiment comes very close to the theoretical optimum.

The energy storage cell 100 shown in FIG. 4 is of identical design in large parts to the cell shown in FIG. 3, with the exception of the contact element 110, comprising the contact sheet 113 here, to which the longitudinal edge 115a of the anode current collector is welded. It additionally comprises the terminal cover 112.

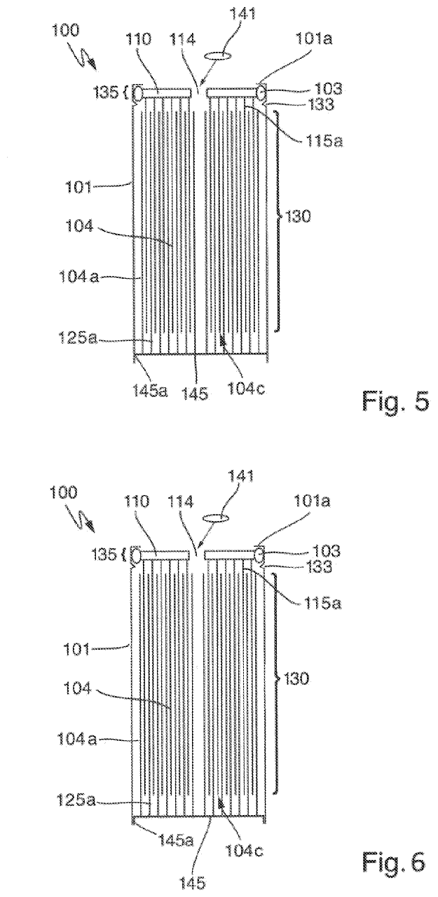

The energy storage cell 100 shown in FIG. 5, as it were, is of identical design in large parts to the cell shown in FIG. 3. The exception is formed here by the closure at the base. Instead of a cup 107, a hollow cylindrical tube is used as housing portion 101, having not one but two terminal openings. While the upper opening is closed as described in connection with FIG. 3, the lower opening is closed by means of the closure element 145. The closure element 145 used is a circular metal disk, the diameter of which corresponds approximately to the internal diameter of the hollow cylindrical tube. The edge 145a of the metal disk 145 is joined to the tubular housing portion via a circumferential weld seam (not shown).

The energy storage cell 100 shown in FIG. 6 differs from the cell in FIG. 5 solely with regard to the shape of the closure element 145. The latter has a circumferential edge bent over by 90°, which enables an edge region of the closure element to lie flat against the inner wall of the housing portion 101. This facilitates welding of the two parts.

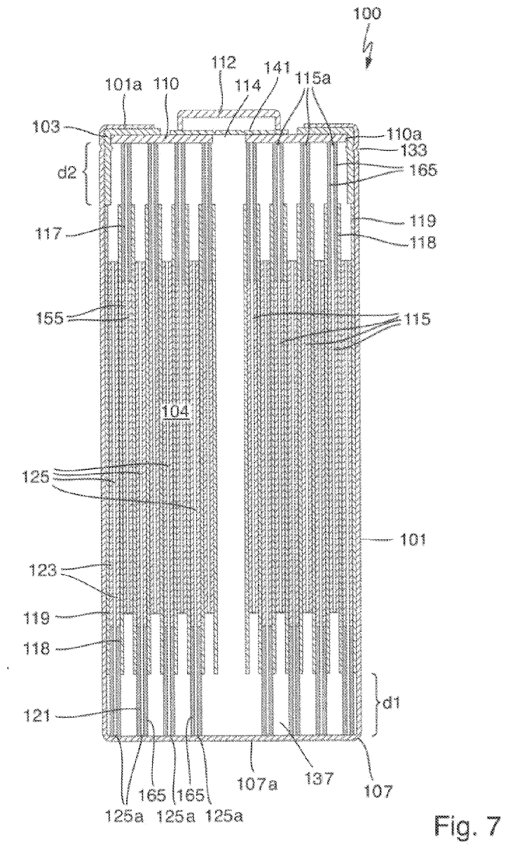

The energy storage cell 100 shown in FIG. 7 comprises a hollow cylindrical housing portion 101 which is part of the housing cup 107 that comprises the circular base 107a and a circular opening (defined by the edge 101a). The housing cup 107 is a deep-drawn part. The housing cup 107 together with the contact element 110, which is a flat metal disk having a circular edge and a central hole 114, which closes the circular opening of the housing cup 107, includes an interior 137 in which the electorate-separator assembly 104 in the form of a winding is axially aligned. The hole 114 served for introduction of an electrolyte into the housing and is closed by means of the sheet metal disk 141. A terminal cover 112 is welded onto the latter. The sheet metal disk 141 has one or more elongated depressions that weaken its structure. It can therefore serve as a pressure relief valve.

The electrode-separator assembly 104 takes the form of a cylindrical winding having two terminal end faces, between which the circumferential winding shell extends, which adjoins the inside of the hollow cylindrical housing portion 101. It is formed from a positive electrode and a negative electrode, and the separators 118 and 119, which are each band shaped and spirally wound.

The two end faces of the electrode-separator assembly 104 are formed by the longitudinal edges of the separators 118 and 119. The current collectors 115 and 125 project from these end faces. The corresponding excess lengths are identified as d1 and d2.

The anode current collector 115 protrudes from the upper end face of the electrode-separator assembly 104, and the cathode current collector 125 from the lower end face. The anode current collector 115, in a strip-shaped main region, is laden with a layer of a negative electrode material 155. The cathode current collector 125, in a strip-shaped main region, is laden with a layer of a positive electrode material 123. The anode current collector 115 has an edge strip 117 which extends along its longitudinal edge 115a and which is not laden with the electrode material 155. Instead, a coating 165 of a ceramic support material is applied here, which stabilizes the current collector in this region. The cathode current collector 125 has an edge strip 121 which extends along its longitudinal edge 125a and which is not laden with the electrode material 123. Instead, the coating 165 of the ceramic support material is applied here too.

The edge 115a of the anode current collector 115 is in direct contact with the contact element 110 over its entire length and is connected thereto by welding (especially with the aid of a laser) at least over multiple sections, preferably over its entire length. Alternatively, the above-described multi-pin bond may be present here. The contact element 112 thus serves simultaneously for electrical contact connection of the anode and as housing portion.

The edge 125a of the cathode current collector 125 is in direct contact with the base 107a over its entire length and is connected thereto by welding (especially with the aid of a laser) at least over multiple sections, preferably over its entire length. Alternatively, the above-described multi-pin bond may be present here too. The base 107a thus serves not only as part of the housing but also for electrical contact connection of the cathode.

The housing portions 101 and 110 are electrically insulated from one another by the seal 103. The edge 101a of the housing portion 101 is bent radially inward about the edge 110a of the contact element 100 which is surrounded by the seal 103 and which fixes the contact element 110 in the circular opening 101c of the tubular housing portion 101. The tubular housing portion 101, in axial direction, comprises a section in which the circumferential winding shell 104a adjoins the inside thereof, and a contact section in which the annular seal 103 adjoins the inside thereof. The annular seal 103 is in compressed form in the contact section as a consequence of a pressure which is exerted thereon by the edge 110a of the contact element 110 and the inside of the tubular housing portion 101.

Immediately below the contact section, the housing portion 101 has the circumferential bead 133. The bead 133 is not very pronounced and projects by less than one housing wall thickness into the interior on the inside of the housing portion 101.

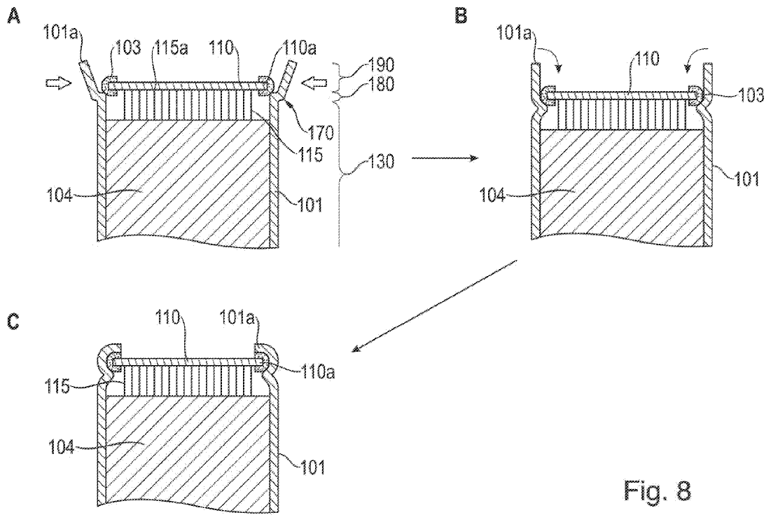

For closure of the terminal circular opening of the housing cup 107 with the contact element, it is possible to proceed according to FIG. 8. The closure is effected in multiple steps. Specifically:

A The electrode-separator assembly 104 in the form of a winding was inserted into the hollow cylindrical housing portion 101, with the anode current collector 115 emerging from the end face thereof. The edge 115a of the anode current collector 115 is in direct contact with the contact element 110 in the form of a disk over its entire length and is connected thereto by welding (especially with the aid of a laser) at least over multiple sections, preferably over its entire length. This weld bond was produced before the insertion of the electrode-separator assembly 104. The annular seal 103 has been pulled over the edge 110a of the contact element 110.

The tubular housing portion 101 in axial direction comprises an essentially cylindrical central section 130, a terminal section 190 that extends up to a circular opening edge, and a transition region 180 in between. The transition region 180 between the cylindrical central section 130 and the terminal section 190 consists in a widening 170 of the internal diameter of the tubular housing portion 101 in the form of a step. The terminal section 190, proceeding from the widening 170 in the form of a step, has a rising internal diameter in the direction of the circular opening edge 101a.

The contact element 110 with the annular seal 130 applied to the edge 110a thereof has an external diameter less than an internal diameter of the tubular housing portion 101 in the terminal section 190, and greater than the internal diameter of the tubular housing portion 101 in the cylindrical central section 130. The electrode-separator assembly 104 is inserted into the tubular housing portion 101 to such an extent that the contact element 110 rests on the widening 170 in the form of a step.

B After the electrode-separator assembly 104 has been inserted, the external diameter of the terminal section 190 is matched to the external diameter of the cylindrical central section 130 by radially indenting the transition region 180 and compressing the seal 103. The bead 133 depicted is formed here. As is clearly apparent, this is beneath the contact element 110. It separates the section in which the housing portion 101 adjoins the seal 101 (contact) from the section 130 (central section) in which the winding adjoins the inside of the housing 101.

C After the external diameter of the terminal section 190 has been matched, the opening edge 101a of the terminal section 190 is bent radially inward about the edge 110a of the contact element 110 surrounded by the seal 103.

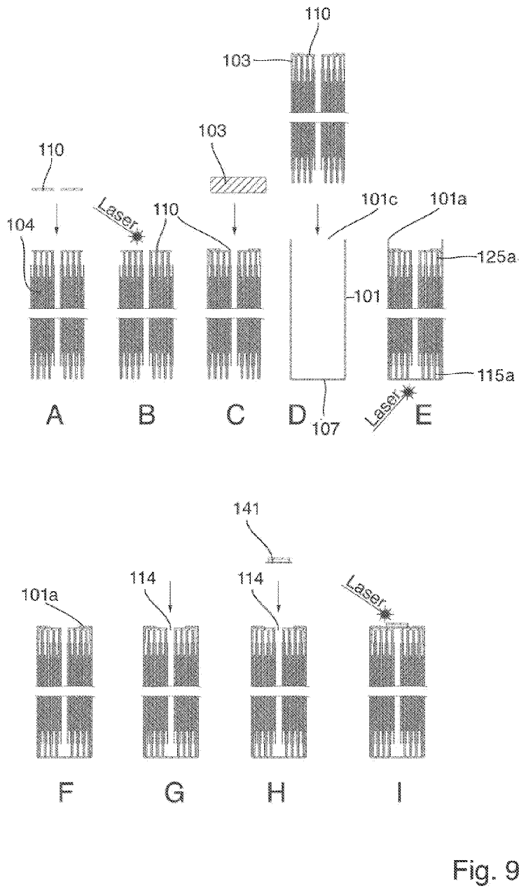

For production of an energy storage cell, it is possible to proceed according to FIG. 9; the individual process steps A to I are described hereinafter. First of all, the electrode-separator assembly 104 is provided, with a metal disk 102 that serves as contact plate 110 placed onto the upper end face thereof. In step B, this is welded to the longitudinal edge 125a of the cathode current collector. In step C, the circumferential seal 103 is pulled onto the edge of the contact plate 110. In step D, this is used to insert the electrode-separator assembly 104 into a housing cup 107 (produced as a deep-drawn part and formed in one piece, and comprising not only a circular base but also a hollow cylindrical housing portion 101 and the terminal circular opening 101c, which is defined by the edge 101a) to such an extent that the longitudinal edge 115a of the anode current collector is in direct contact with the base of the housing cup 107. In step E, this is welded to the base of the housing cup 107. In step F, the opening edge 101a is bent over radially inward. In step G, the housing is filled with electrolyte, which is dispensed into the housing through the opening 114. The opening 114 is closed in steps H and I by means of the sheet metal part 141 which is welded onto the housing portion 110.

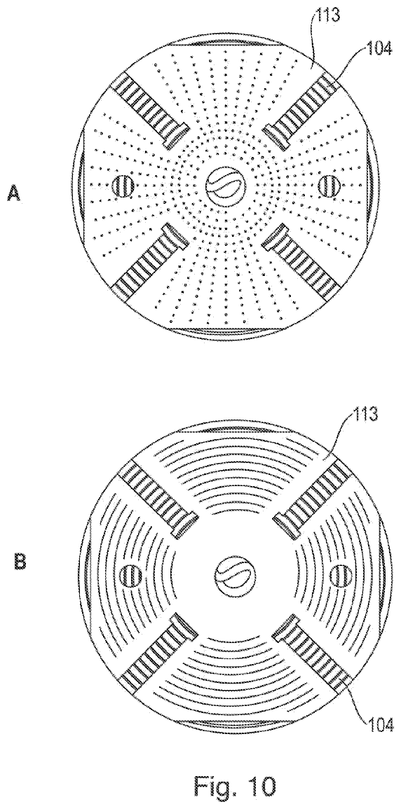

The working examples shown in FIG. 10 illustrate contact connection variants for attachment of the longitudinal edges of current collectors having spiral structure to a contact sheet. Specifically:
A Here, a longitudinal edge of a current collector directly adjoins a contact sheet and is bonded to the contact sheet via a multitude of spot weld bonds (called a multi-pin bond).
B Here, a longitudinal edge of a current collector directly adjoining a contact sheet is fixed to the contact sheet via a multitude of sections, each of which is connected to the contact sheet over its entire length by a continuous weld seam.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An energy storage cell, comprising:
an electrode-separator assembly comprising an anode, a cathode, and a separator having a sequence of anode/separator/cathode, wherein
the electrode-separator assembly is in form of a cylindrical winding having two terminal end faces and a winding shell between the two terminal end faces, wherein the anode is in a band shape and comprises a band shaped anode current collector comprising a first longitudinal edge, a second longitudinal, edge, and two end pieces, wherein the cathode is in a band shape and comprises a band shaped cathode current collector comprises a first longitudinal edge, a second longitudinal edge, and two end pieces;
a housing comprising a metallic, tubular housing portion with a terminal circular opening, wherein the electrode-separator assembly in the form of the cylindrical winding is aligned axially in the housing, wherein the tubular housing portion comprises a central section in which the winding shell of the cylindrical winding adjoins an inner side of the tubular housing portion;
an at least partly metallic contact element comprising a circular edge, the contact element being in direct contact with and connected to a first respective first longitudinal edge, the first respective first longitudinal edge being the first longitudinal edge of the anode current collector or the first longitudinal edge of the cathode current collector, and
an annular seal made of an electrically insulating material that surrounds the circular edge of the contract element,
wherein the anode current collectors comprises a strip-shaped main region laden with a layer of negative electrode material, and a free edge strip not laden with the negative electrode material that extends along the first longitudinal edge of the anode current collector,
wherein the cathode current collector comprises a strip shaped main region laden with a layer of positive electrode material, and a free edge strip not laden with the negative electrode material that extends along the first longitudinal edge of the cathode current collector,
wherein the anode and the cathode are arranged within the electrode-separator assembly such that the first longitudinal edge of the anode current collector protrudes from a first respective terminal end face of the electrode winding and the first longitudinal edge of the cathode current collector protrudes from a second respective terminal end face of the electrode winding,
wherein the contact element together with the seal closes the terminal circular opening of the tubular housing portion,
wherein the tubular housing portion comprises a contact section in which the annular seal adjoins the inner side of the tubular housing portion, and
wherein the central section of the tubular housing portion is separated from the contact section of the tubular housing portion by a depression that circularly surrounds an outer side of the tubular housing portion.

2. The cell as claimed in claim 1, wherein at least one of:
the contact element is or comprises a metal disk, an edge of which corresponds to or forms at least part of the circular edge of the contact element,
the contact element is arranged in the tubular housing portion such that the annular seal runs along a circumferential contact zone on the inner side of the tubular housing portion,
the annular seal is in compressed form in the contact zone as a consequence of a pressure exerted thereon by the edge of the contact element and the inner side of the tubular housing portion, and/or
the selected respective first longitudinal edge directly adjoins the contact element and is bonded to the contact element by welding.

3. The cell as claimed in claim 1, wherein at least one of:
the contact element comprises a metal disk, an edge of which corresponds to or forms at least part of the circular edge of the contact element,
the contact element is arranged in the tubular housing portion such that the annular seal runs along a circumferential contact zone on the inner side of the tubular housing portion,
the annular seal is in compressed form in the contact zone as a consequence of a pressure exerted thereon by the edge of the contact element and the inner side of the tubular housing portion,
the contact element comprises a metallic contact sheet having a first side facing in a direction of the metal disk and being bonded to the metal disk by welding, and/or
the selected respective first longitudinal edge directly adjoins a second side of the contact sheet and is bonded thereto.

4. The cell as claimed in claim 2, wherein a region of the circumferential depression, the external diameter of the tubular housing portion is reduced by not more than 2 to 6 times the wall thickness of the housing in the region of the circumferential depression.

5. The cell as claimed in claim 4, wherein:
the tubular housing portion comprises a circular edge which is bent radially inward about the edge of the contact element which is surrounded by the seal and which fixes the contact element in the circular opening of the tubular housing portion, and/or
the contact section extends in the axial direction on the depression up to the edge bent radially inward.

6. The cell as claimed in claim 1, wherein:
the tubular housing portion is part of a housing cup comprising a circular base, and/or
a second respective first longitudinal edge different than the first respective first longitudinal edge directly adjoins the base and is bonded to the base the second respective first longitudinal edge being the first longitudinal edge of the cathode current collector or the first longitudinal edge of the anode current collector.

7. The cell as claimed in claim 1, wherein:
the tubular housing portion has a second terminal circular opening,
the cell further comprises a closure element having a circular edge that closes the second terminal opening, and
the closure element is or comprises a metal disk, an edge of which corresponds to or forms part of the circular edge of the closure element.

8. The cell as claimed in claim 7, wherein at least one of:
the metal disk is arranged in the tubular housing portion such that the edge thereof runs along a circumferential contact zone on the inner side of the tubular housing portion,
the edge of the metal disk is joined to the tubular housing portion via a circumferential weld seam, and/or
the tubular housing portion comprises a circular edge bent radially inward about the circular edge of the closure element.

9. The cell as claimed in claim 7, wherein:
a second respective first longitudinal edge different than the first respective first longitudinal edge directly adjoins the metal disk and is joined to the metal disk, the second respective first longitudinal edge being the first longitudinal edge of the cathode current collector or the first longitudinal edge of the anode current collect, and/or
the second respective first longitudinal edge is welded to a contact sheet that directly adjoins the metal disk.

10. The cell as claimed in claim 7, wherein at least one of:
the cell comprises a second annular seal made of an electrically insulating material that surrounds the circular edge of the closure element,
the metal disk is arranged in the tubular housing portion such that the second annular seal runs along a circumferential contact zone on the inner side of the tubular housing portion,
the second annular seal is in compressed form in the circumferential contact zone as a consequence of a pressure when exerted thereon by the edge of the metal disk and the inner side of the tubular housing portion, and/or
the tubular housing portion comprises a circular edge which is bent radially inward about the edge of the closure element that is surrounded by the second annular seal and that fixes the closure element in the second terminal opening of the tubular housing segment.

11. The cell as claimed in claim 10, wherein:
a second respective first longitudinal edge different than the first respective first longitudinal edge directly adjoins the metal disk and is joined to the metal disk by welding, the second respective first longitudinal edge being the first longitudinal edge of the cathode current collector or the first longitudinal edge of the anode current collector, and/or
the second respective first longitudinal edge is welded to a contact sheet that directly adjoins the metal disk.

12. A method of producing an energy storage cell, the method comprising:
providing an electrode-separator assembly comprising an anode, a cathode, and a separator having a sequence of anode/separator/cathode, wherein the electro-separator assembly is in a form of a cylindrical winding with two terminal end faces and a winding shell between the two terminal end faces, wherein the anode is in a band shape and comprises a band shaped anode current collector comprising a first longitudinal edge a second longitudinal edge and two end pieces, wherein the cathode is in a band shape and comprises a and shaped cathode current collector having a first longitudinal edge, a second longitudinal edge, and two end pieces, and wherein a first respective first longitudinal edge protrudes from a first respective terminal end face of the two terminal end faces of the cylindrical winding, the first respective first longitudinal edge being the first longitudinal edge of the anode current collector or the first longitudinal edge of the cathode current collector,
providing a tubular housing portion with a terminal circular opening;
providing an at least partly metallic contact element with a circular edge;
applying an annular seal made of an electrically insulating material to the circular edge of the contact element;
welding the first respective first longitudinal to the contact element or to a metallic component of the contact element,
inserting the electrode-separator assembly through the terminal circular opening into the tubular housing portion such that the winding shell of the cylindrical winding adjoins, in a central section of the tabular housing portion, an inner side of the tubular housing portion and such that the annular seal applied to the circular edge of the contact element runs, in a contact section of the tubular housing portion along a circumferential contact zone on the inner side of the tubular housing portion, and
exerting a radially directed pressure on the tubular housing portion, such that the inner side of the tubular housing portion is pressed against the circular edge of the contact element and the annular seal is subjected to a pressure and compressed,
wherein the tubular housing portion comprises, in an axial direction, the central section, which is essentially cylindrical, a terminal section that extends up to a circular opening edge, and a transition region between the central section and the terminal section,
wherein the transition region between the cylindrical central section and the terminal section includes a widening, in the form of a step, of the internal diameter of the tubular housing portion,
wherein the contact element with the annular seal applied to the edge thereof has an external diameter less than an internal diameter of the tubular housing portion in the terminal section, and greater than the internal diameter of the tubular housing portion in the cylindrical central section, and
wherein the electrode-separator assembly is inserted into the tubular housing portion to such an extent that the contact element rests on the widening in the form of the step.

13. The method as claimed in claim 12, wherein
the terminal section, proceeding from the widening in the form of the step, has a rising internal diameter in a direction of the circular opening edge, and/or
the electrode-separator assembly is inserted into the tubular housing portion to such an extent that the contact element rests on the widening in the form of the step.

14. The method as claimed in claim 13, wherein:
after the electrode-separator assembly has been inserted, the external diameter of the terminal section is matched to the external diameter of the cylindrical central section by radially indenting the transition region and compressing the seal, and/or
after the external diameter of the terminal section has been matched, the opening edge of the terminal section is bent radially inward about the edge of the contact element surrounded by the seal.

15. The method as claimed in claim 12, wherein at least one of:
the electrode-separator assembly is impregnated with an electrolyte, wherein the electrolyte is introduced through an aperture in the contact element or another housing portion,
after the electrolyte has been introduced, the aperture is closed, and/or
the aperture is closed by using a pressure relief device.
